(19) United States
(12) Patent Application Publication
(10) Pub. No.: US 2017/0181470 A1
(43) Pub. Date: Jun. 29, 2017

(54) E-CIGARETTE INTEGRATED WITH FUNCTIONS OF GRINDING, CUTTING AND HEATING

(71) Applicant: Lrider Technology Co., Ltd., Shenzhen (CN)

(72) Inventor: Yongsheng Li, Shenzhen (CN)

(73) Assignee: Lrider Technology Co.,Ltd, Shenzhen (CN)

(21) Appl. No.: 14/979,509

(22) Filed: Dec. 27, 2015

(51) Int. Cl. A24F 47/00; H02J 7/00; H05B 3/14; A24B 7/04; A24F 3/00

(52) U.S. Cl. CPC A24F 47/008; A24B 7/04; A24F 3/00; H05B 3/141; H02J 7/0042; H02J 7/0029; H02J 7/0047

(57) ABSTRACT

This invention discloses an e-cigarette, integrated with functions of grinding, cutting and heating, comprising a case, wherein: the case is divided into a smoke control room and a grinding-cutting-hewing room. Upper part of the grinding-cutting-heating room comprises a tobacco grinding-cutting module and a heater and lower part of it comprises a rotatable ash funnel. A hole is set on the bottom of the ash funnel and combined with an air vent located on the bottom of the case to form a smoke ventilating passage. The upper part of the smoke control room comprises a cigarette holder, the cigarette holder connects a flexible conduit via a connector. The flexible conduit is connected to the grinding-cutting-heating room located on the other side. The lower part of the smoke control room comprises a power source, and the power source is connected to a PCBA on the same side.

### TECHNICAL FIELD

This invention relates to the technical field of e-cigarette, more specifically, relates to an e-cigarette integrated with functions of grinding, cutting and heating.

### BACKGROUND

It has been more than 300 years since tobacco was introduced into China in 18th century. As time goes on, various smoking sets emerge in an endless stream and each of them has its own functions. Taking e-cigarette as an example, when using the smoking set in the current market, the tobacco needs to be processed into shredded tobacco, which is complicated and costs a lot. It is also easy to cause wasting while adding the shredded tobacco into the smoking set. Naked flame is required to light the shredded tobacco which would create harmful tar, more than 460 chemical substances which would cause diseases relating to the respiratory system and the cardiovascular system carcinogen and “second hand smoke”, and would also pollute the environment. Moreover, the homogeneous products are usually heated by the Nickel-Cadmium alloy filament, which cannot provide evenly heat and cause excessive local temperature. As a result, the shredded tobacco is easy to be charted and tastes bad. Furthermore, it is not convenient to deal with the tobacco ash left by the burned tobacco, and while smoking the excessive high temperature of the smoke took in the mouth would easily scald the mouth. Therefore, there are lots of improvements required to be made on the electronic smoking set.

### SUMMARY OF THE INVENTION

In order to overcome above disadvantages existing in the current technology, the goal of this invention is to provide an e-cigarette integrated with functions of grinding, cutting and heating, which integrates the functions of grinding and cutting and heating for the tobacco. Grinding and cutting is easy to be manipulated which avoids the wasting of tobacco. It would reduce the creation of harmful substance by exactly controlling the heating temperature via PCBA and using a new heater to bake tobacco at a lower temperature.

The technology provided in this invention for solving the mentioned problems is as follows;

an e-cigarette, integrated with functions of grinding, cutting and heating, comprises a case, wherein: the case is divided into a smoke control room and a grinding-cutting-heating room. The grinding-cutting-heating room is designed as a circle cavity structure, an upper part of which comprises a tobacco grinding-cutting module and a heater, a lower part of which comprises a rotatable ash funnel. A hole is set on the bottom of the ash funnel and combined with an air vent located on the bottom of the case to form a smoke ventilating passage. An upper part of the smoke control room comprises a cigarette holder, wherein the cigarette holder connects a flexible conduit via a connector. The flexible conduit is connected to the grinding-cutting-heating room located on the other side. A lower part of the smoke control room comprises a power source, and the power source is connected to a PCBA (Printed Circuit Board Assembly) on the same side. The PCBA comprises a function key, up/down adjusting keys, a display screen and a recharging interface.

As a further improvement of this invention, the tobacco grinding-cutting module comprises an upper reamer, a lower reamer, a pushrod connected to the upper reamer which is configured to push or rotate the upper reamer to grind and cut the tobacco, a cone-shaped spring sleeved on the lower reamer which is configured to move up and down with the lower reamer, and an adjusting screw connected to the lower reamer which is configured to adjust the altitude of the lower reamer.

As a further improvement of this invention, the rotatable ash funnel can be rotated and taken out, in order to add or clean the tobacco or tobacco ash.

As a further improvement of this invention, a transparent sheet is set on one side of the grinding-cutting-heating room, which is used to observe the grinding and cutting circumstances and the amount of the tobacco. The cigarette holder is made up of glass, and the heater is a heating ceramic plate.

As a further improvement of this invention, the power source is a rechargeable battery.

As a further improvement of this invention, a method for using the e-cigarette integrated with the functions of grinding, cutting and heating, comprises the steps as follows:

turning the e-cigarette on: continuously pressing the function key 5 times to turn on the e-cigarette;

adjusting the temperature for baking the tobacco: after the e-cigarette is powered on for 2.5 seconds, adjusting the temperature for baking the tobacco by the up/down adjusting keys; increasing 1 degree for the temperature by pressing the up adjusting key once, and decreasing 1 degree for the temperature by pressing the down adjusting key once; increasing/decreasing 1 degree for the temperature every 0.3 seconds by long pressing the up/down adjusting key;

starting smoking and stopping smoking: starting smoking by long pressing the function key for 1 second, stopping smoking by long pressing the function key again for another 1 second. At this time the LED indicator light will keep on and the display screen displays the current baking temperature for the tobacco;

time limit protection for the e-cigarette: once the heating time reaches 10 minutes, the control system of the e-cigarette will sleep automatically and shut down the heat output of the heater;

low voltage protection for the e-cigarette: if smoking when a battery voltage is lower than 3.3V, an LED backlight will flash 3 times to remind that the e-cigarette needs recharging, and the e-cigarette stops working;

short-circuit protection for the e-cigarette: entering a protection alerting state once the heater is short, out in, the LED backlight will flash 5 times and the heat output of the heater will be shut down;

turning the e-cigarette off: automatically turning off the e-cigarette after 60 seconds without actions of recharging or smoking.

Comparing with the existing technology, the advantage of this invention is: this invention is designed as integrating the functions of grinding, cutting and heating; the grinding-cutting-heating room is designed as a circle cavity structure so that a lot of tobacco can be added in and as a result the service life is prolonged; the tobacco can be completely mixed and grinded by the tobacco grinding-cutting module, which is easy to manipulate and avoids wasting of the tobacco; the internal PCBA can accurately control the heat temperature of the heater; it can reduce the creation of the harmful substances during the heating process of the tobacco and hemp plant by low-temperature heating and baking for the tobacco via the heater; at the same time, there is a rotatable ash funnel that can be rotated 90 degree to dump the tobacco ash, which is convenient for cleaning up, and avoiding the ash being too disheveled to destroy the cleaning.

### BRIEF DESCRIPTION OF THE DRAWING

FIG. 1 is a schematic diagram of this invention.

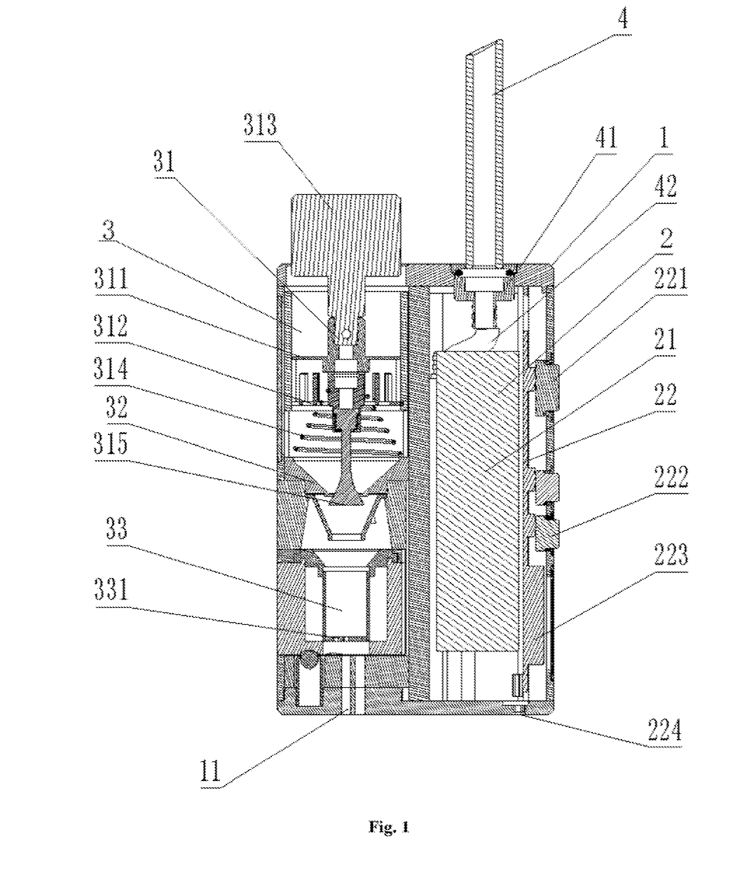

### DETAILED DESCRIPTION OF THE INVENTION

This invention will be further described in conjunction of the figures and embodiments:

An e-cigarette integrated with functions of grinding, cutting and heating, comprises a case 1, wherein: the case 1 is divided into a smoke control room 2 and a grinding-cutting-heating room 3. The grinding-cutting-heating room 3 is designed as a circle cavity structure, an upper part of which comprises a tobacco grinding-cutting module 31 and a heater 32 and a lower part of which comprises a rotatable ash funnel 33. A hole 331 is set on the bottom of the ash funnel 33 and combined with an air vent 11 located on the bottom of the case 1 to form a smoke ventilating passage. The upper part of the smoke control room 2 comprises a cigarette holder 4, the cigarette holder 4 connects a flexible conduit 42 via a connector 41. The flexible conduit 42 is connected to the grinding-cutting-heating room 3 located on the other side. The lower part of the smoke control room 2 comprises a power source 21, and the power source 21 is connected to a PCBA (Printed Circuit Board Assembly) 22 on the same side. The PCBA 22 comprises a function key 221, up/down adjusting keys 222, a LED indicator light, a display screen 223 and a recharging interface 224.

The tobacco grinding-cutting module 31 comprises an upper reamer 311, a lower reamer 312, a pushrod 313 connected to the upper reamer 311 which is configured to push or rotate the upper reamer 311 to grind and cut the tobacco, a cone-shaped spring 314 sleeved on the lower reamer 312 which is configured to move up and down with the lower reamer 312, and an adjusting screw 315 connected to the lower reamer 312 which is configured to adjust the altitude of the lower reamer 312.

The rotatable ash funnel 33 can be rotated out, in order to add or clean the tobacco or tobacco ash.

A transparent sheet is set on the grinding-cutting-heating room 3, which is used to observe the grinding and cutting circumstances and the amount of the tobacco. The cigarette holder 4 is made of glass.

A method for using the e-cigarette integrated with the functions of grinding, cutting and heating, comprises the steps as follows:

turning the e-cigarette on: continuously pressing the function key 5 times to turn on the e-cigarette;

adjusting the temperature for baking the tobacco: after the e-cigarette is powered on for 2.5 seconds, adjusting the temperature for baking the tobacco by the up/down adjusting keys: increasing 1 degree for the temperature by pressing, the up adjusting key once, and decreasing 1 degree for the temperature by pressing the down adjusting key once; increasing/decreasing 1 degree for the temperature every (13 seconds by long pressing the up/down adjusting key;

starting smoking and stopping smoking: starting smoking by long pressing the function key for 1 second, stopping smoking by long pressing the function key again for another 1 second, at this time the LED indicator light will keep on and the display screen displays the current baking temperature for the tobacco;

time limit protection for the e-cigarette: once the heating time reaches 10 minutes, the control system of the e-cigarette will sleep automatically and shut down the heat output of the heater;

low voltage protection for the e-cigarette: if smoking when a battery voltage is lower than 3.3V, an LED backlight will flash 3 times to remind that the e-cigarette needs recharging, and the e-cigarette stop working;

short-circuit protection for the e-cigarette: entering a protection alerting state once the heater is short out in, the LED backlight will flash 5 times and the heat output of the heater will be shut down;

turning the e-cigarette off: automatically turning off the e-cigarette after 60 seconds without actions of recharging or smoking.

When using the e-cigarette, continuously pressing the function key 5 times to turn on the e-cigarette, and then taking out the upper reamer via the pushrod, and then putting the tobacco to the grinding-cutting-heating room, the amount of the put tobacco is subject to exceeding the position of the lower reamer, and then put the upper reamer in the grinding-cutting-heating room, and continually rotating the pushrod and pressing the pushrod in an up-down motion, therefore the tobacco can be completely grinded and cut by the upper reamer and lower reamer, and then the user can start smoking by pressing the function key and holding the glass cigarette holder, after finishing smoking, rotating the ash funnel 90 degree and dumping the tobacco ash. This invention is easy to manipulate, provides double smoking, time than normal cigarette, greatly reduces creation of harmful gas,and decreases the danger of “second hand smoke” for surrounding people.

As described above, any corresponding modification made by one of ordinary skill in the art without creative effort should be considered as falling within the protection scope of this invention.

What claimed is:

1. An e-cigarette integrated with functions of grinding, cutting and heating, comprises a case, w herein
the case is divided into a smoke control room and a grinding-cutting-heating room; the grinding-cutting-heating room is designed as a circle cavity structure, an upper part of which comprises a tobacco grinding-cutting module and a heater and a lower part of which comprises a rotatable ash funnel;
a hole is set on the bottom of the ash funnel and combined with an air vent located on the bottom of the case to form a smoke ventilating passage;
an upper part of the smoke control room comprises a cigarette holder, wherein the cigarette holder connects a flexible conduit via a connector; the flexible conduit is connected to the grinding-cutting-heating room located on the other side; the lower part of the smoke control room comprises a power source, and the power source is connected to a PCBA (Printed Circuit Board Assembly) on the same side; the PCBA comprises a function key, a up adjusting key, a down adjusting key, a display screen and a recharging interface.

2. The e-cigarette according to claim 1, wherein the tobacco grinding-cutting module comprises an upper reamer, a lower reamer, a pushrod connected to the upper reamer which is configured to push or rotate the upper reamer to grind and cut the tobacco, a cone-shaped spring connected to the lower reamer which is configured to move up and down with the lower reamer, and an adjusting screw connected to the lower reamer which is configured to adjust an altitude of the lower reamer.

3. The e-cigarette according to claim 2, wherein the rotatable ash funnel is configured to be rotated out in order to add tobacco or clean tobacco ash.

4. The e-cigarette according to claim 1, wherein a transparent sheet is set on the grinding-cutting-heating room, the transparent sheet is used to observe the grinding and cutting circumstances and the amount of the tobacco, wherein the cigarette holder is made of glass.

5. A method for using the e-cigarette according to claim 1, wherein the method comprising the steps of:
turning the e-cigarette on: continuously pressing the function key 5 times to turn on the e-cigarette;
adjusting the temperature for baking the tobacco: after the e-cigarette is powered on for 2.5 seconds, adjusting the temperature for baking the tobacco by the up/down adjusting keys: increasing 1 degree for the temperature by pressing the up adjusting key once, and decreasing 1 degree for the temperature by pressing the down adjusting key once; increasing/decreasing 1 degree for the temperature every 0.3 seconds by long pressing the up/down adjusting key;
starting smoking and stopping smoking: starting smoking by long pressing the function key for 1 second and stopping smoking by long pressing the function key again for another 1 second, at which fine the LED indicator light keeps on and the display screen displays the current baking temperature for the tobacco;
time limit protection for the e-cigarette: going to sleep and shutting down the heater once the heating time reaches 10 minutes;
low voltage protection for the e-cigarette: flashing the LED backlight 3 times and stopping the e-cigarette if the battery voltage is lower than 3.3V;
short-circuit protection for the e-cigarette: flashing the LED backlight 5 times and shutting down the heater once the heater is short out;
turning the e-cigarette off: turning off the e-cigarette after 60 seconds without actions of recharging or smoking.
